(19) United States
(12) Patent Application Publication
(10) Pub. No.: US 2024/0007905 A1
(43) Pub. Date: Jan. 4, 2024

(54) DYNAMIC CHANGE OF ACTIVE QUEUE MANAGEMENT (AQM) LOCATION

(71) Applicant: Telefonaktiebolaget LM Ericsson (publ), Stockholm (SE)

(72) Inventors: Martin Skarve, Enebyberg (SE); Samir Shah, Ottawa (CA); Stefan Eng, Linköping (SE); Torbjörn Örtengren, Linköping (SE); Svante Järvstråt, Linköping (SE); Björn Knuthammar, Linköping (SE)

(21) Appl. No.: 17/908,567

(22) PCT Filed: Mar. 24, 2021
(86) PCT No.: PCT/SE2021/050259

§ 371 Date: Sep. 1, 2022

Related U.S. Application Data
(60) Provisional application No. 63/000,908, filed on Mar. 27, 2020.

(51) Int. Cl. H04W 28/12

(52) U.S. Cl. CPC H04W 28/12

(57) ABSTRACT

Methods for dynamically triggering a Flow Control (FC) configuration change. The methods, which can be performed by a wireless device and/or a base station, involve determining whether there is a need to trigger the FC configuration change and triggering the FC configuration change in response to determining that the FC configuration change is needed. The FC configuration change includes switching between an FC activated state, in which FC and aggregation are enabled and Active Queue Management (AQM) is configured for a Packet Data Convergence Protocol (PDCP) Service Data Unit (SDU) buffer, and an FC deactivated state, in which FC and aggregation are disabled and AQM is configured for a Radio Link Control (RLC) SDU buffer. By dynamically triggering the FC configuration change, it is possible to enable FC and aggregation based on traffic volume on a Radio Bearer (RB) such that the benefit of aggregation can be realized when needed.

### RELATED APPLICATIONS

This application claims the benefit of provisional patent application Ser. No. 63/000,908, filed Mar. 27, 2020, the disclosure of which is hereby incorporated herein by reference in its entirety.

### TECHNICAL FIELD

The technology of the disclosure relates generally to using Flow Control (FC) and Active Queue Management (AQM) for Dual Connectivity (DC) and aggregation.

### BACKGROUND

Dual Connectivity (DC) is used to enable a single split radio bearer to transmit data to a UE using two nodes. For example, DC is required for the very first 5G technology when one eNB is connected to a gNB using the X2 interface. A User Equipment (UE) using DC can have a so-called Split Radio Bearer configured and such Radio Bearer (RB) can transmit data over either one of the two radio interfaces (legs) or both. The latter scenario (e.g., transmitting over two legs) is hereinafter referred to as aggregation, which can achieve a higher peak rate than transmitting over a single leg. A New Radio (NG) base station, which is commonly referred to as gNB, may be further split into three (3) parts, namely a Central Unit—Control Plane (CU-CP), a Central Unit—User Plane (CU-UP), and a Distributed Unit (DU), as illustrated in FIGS. 1 and 2. A split RB has one Packet Data Convergence Protocol (PDCP) entity located in the CU-UP and two Radio Link Control (RLC) and lower layer independent entities located in the DU for each of the two legs.

The performance when using aggregation in DC is heavily dependent on a minimal reordering difference between packets received by the UE when sent over the two legs. This is achieved using a Flow Control (FC) algorithm when sending data from the PDCP protocol entity towards the two nodes (e.g., legs) with RLC and lower protocol layers. FC maintains a short, but not too short, RLC Service Data Unit (SDU) buffer for each leg, while all excess data packets received from the S1-U interface are stored in the PDCP SDU buffer. As of today, it is not expected that aggregation can be performed efficiently without using FC. Notably, 3GPP TS 38.425 defines FC feedback as Downlink Data Delivery Status (DDDS) but leaves the FC algorithm to individual implementation.

There may be two main drawbacks when the FC algorithm is active:
increased FC feedback intensity aimed to achieve good performance may introduce processing and Transport Network (TN) load (e.g., overhead)
storing/retrieving packets in the PDCP SDU buffer may introduce high processing load

In this regard, it is common to introduce buffer management in Radio Access Network (RAN) (and in Internet as such) to minimize buffering latency (bufferbloat). For example, the buffer management is typically enabled in such a way that a packet in a buffer is discarded when an age of the packet in the buffer exceeds a preconfigured value. Such packet discard can trigger a transmission back off at the Transport Control Protocol (TCP)/application server and, thus leading to a shorter buffer and latency. This buffer management functionality is hereinafter referred to as Active Queue Management (AQM). Notably, AQM can help reduce storage memory requirement, particularly in high rate deployments. In addition, AQM can help reduce latency and response time for an end user. As such, it may be desirable to employ FC and AQM when using DC and aggregation.

### SUMMARY

Embodiments disclosed herein include methods for dynamically triggering a Flow Control (FC) configuration change. The methods can be performed by a wireless device and/or a base station. Specifically, the methods involve determining whether there is a need to trigger the FC configuration change and triggering the FC configuration change in response to determining that the FC configuration change is needed. In a non-limiting example, the FC configuration change includes switching between an FC activated state, in which FC and aggregation are enabled and Active Queue Management (AQM) is configured for a Packet Data Convergence Protocol (PDCP) Service Data Unit (SDU) buffer, and an FC deactivated state, in which FC and aggregation are disabled and AQM is configured for a Radio Link Control (RLC) SDU buffer. By dynamically triggering the FC configuration change, it is possible to enable FC and aggregation based on traffic volume on a Radio Bearer (RB) such that the benefit of aggregation can be realized when needed.

In one embodiment, a method performed by a wireless device for dynamically triggering an FC configuration change is provided. The method includes determining whether there is a need to trigger the FC configuration change. The method also includes triggering the FC configuration change in response to determining that the FC configuration change is needed.

In another embodiment, determining the need to trigger the FC configuration change comprises one of determining the need to trigger the FC configuration change to switch from an FC activated stated to an FC deactivated state and determining the need to trigger the FC configuration change to switch from the FC deactivated state to the FC activated state. Triggering the FC configuration change comprises one of triggering the FC configuration change to switch from the FC activated stated to the FC deactivated state and triggering the FC configuration change to switch from the FC deactivated state to the FC activated state.

In another embodiment, the FC activated state comprises enablement of FC and aggregation and configuration of AQM for a PDCP SDU buffer, and the FC deactivated state comprises disablement of FC and aggregation and configuration of AQM for an RLC SDU buffer.

In another embodiment, determining the need to trigger the FC configuration change further comprises determining a trigger criteria to trigger the FC configuration change based on one or more of: a load condition, an admission condition, and an estimated or measured characteristic expected to require activation or deactivation of FC and aggregation.

In another embodiment, triggering the FC configuration change further comprises one or more of configuring the FC configuration change via user plane signaling and configuring the FC configuration change via control plane signaling.

In another embodiment, the user plane signaling and/or the control plane signaling are provided in one or more of the following methods: a spare bit(s) in a header of downlink user data frame, a multi-bit field, a new user plane message, and a control plane message.

In another embodiment, user plane signaling and/or the control plane signaling is provided via an existing header or a proprietary extension to the header of downlink user data frame.

In another embodiment, triggering the FC configuration change further comprises one or more of: changing between the FC activated state and the FC deactivated state at Central Unit Control Plane, CU-UP, and changing between AQM low intensity Downlink Data Delivery Status, DDDS, feedback and AQM high intensity DDDS feedback.

In another embodiment, a wireless device is provided. The wireless device includes processing circuitry and transceiver circuitry configured to cause the wireless device to determine whether there is a need to trigger the FC configuration change and trigger the FC configuration change in response to determining that the FC configuration change is needed. The wireless device also includes power supply circuitry configured to supply power to the wireless device.

In another embodiment, the processing circuitry is further configured to cause the wireless device to perform any of the steps performed by the wireless device.

In another embodiment, a method performed by a base station for dynamically triggering an FC configuration change is provided. The method includes determining whether there is a need to trigger the FC configuration change. The method also includes triggering the FC configuration change in response to determining that the FC configuration change is needed.

In another embodiment, determining the need to trigger the FC configuration change comprises determining whether there is a need to trigger the FC configuration change for an RB comprising multiple legs each corresponding to a respective one of multiple Distributed Units, DUs, in the base station, and the FC configuration change comprises sending an indication from a User Plane Control Unit in the base station to the multiple DUs to change the FC configuration.

In another embodiment, the FC activated state comprises enablement of FC and aggregation and configuration of AQM for a PDCP SDU buffer, and the FC deactivated state comprises disablement of FC and aggregation and configuration of AQM for an RLC SDU buffer.

In another embodiment, determining the need to trigger the FC configuration change further comprises determining a trigger criteria to trigger the FC configuration change based on one or more of: a load condition, an admission condition, and an estimated or measured characteristic expected to require activation or deactivation of FC and aggregation.

In another embodiment, triggering the FC configuration change further comprises one or more of: configuring the FC configuration change via user plane signaling and configuring the FC configuration change via control plane signaling.

In another embodiment, the user plane signaling and/or the control plane signaling are provided in one or more of following methods: a spare bit(s) in a header of downlink user data frame, a multi-bit field, a new user plane message, and a control plane message.

In another embodiment, the user plane signaling and/or the control plane signaling is provided via an existing header or a proprietary extension to the header of downlink user data frame.

In another embodiment, triggering the FC configuration change further comprises one or more of: changing between the FC activated state and the FC deactivated state at CU-UP and changing between AQM low intensity DDDS feedback and AQM high intensity DDDS feedback.

In another embodiment, a base station is provided. The base station includes a control system configured to cause the base station to determine whether there is a need to trigger the FC configuration change and trigger the FC configuration change in response to determining that the FC configuration change is needed.

In another embodiment, the control system is further configured to cause the base station to perform any of the steps performed by the base station.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a schematic diagram illustrating a New Radio (NR) base station (gNB) that is split into three (3) parts;

FIG. 2 is a schematic diagram illustrating the gNB in FIG. 1 that includes a Central Unit-Control Plane (CU-CP), a Central Unit-User Plane (CU-UP), and a Distributed Unit (DU);

FIG. 3 illustrates one example of a cellular communications system in which embodiments of the present disclosure may be implemented;

FIG. 4 is a flowchart of an exemplary method performed by a wireless device.

FIG. 5 is a flowchart of an exemplary method performed by a base station.

FIG. 6 is a flowchart of an exemplary process performed by a radio node (e.g., a base station and/or a wireless device) for dynamically switching between an FC activated state and an FC deactivated state in accordance with one embodiment of the present disclosure;

FIG. 7 is a schematic diagram providing an exemplary illustration of one of spare bits in the header of the Downlink User Data frame, as specified in TS 38.425, which can be used to indicate the FC activated state and the FC deactivated state;

FIG. 8 provides an exemplary illustration of the FC activated state (left figure) and the FC deactivated state (right figure);

FIG. 9 is a flowchart of an exemplary method, which can be performed by a radio node (e.g., a base station and/or a wireless device), for dynamically switching between an FC activated state and an FC deactivated state;

FIG. 10 is a schematic block diagram of a radio access node according to some embodiments of the present disclosure;

FIG. 11 is a schematic block diagram that illustrates a virtualized embodiment of the radio access node according to some embodiments of the present disclosure;

FIG. 12 is a schematic block diagram of the radio access node according to some other embodiments of the present disclosure;

FIG. 13 is a schematic block diagram of a wireless communication device according to some embodiments of the present disclosure;

FIG. 14 is a schematic block diagram of the wireless communication device according to some other embodiments of the present disclosure;

FIG. 15 is a schematic block diagram of a communication system in accordance with an embodiment of the present disclosure;

FIG. 16 is a schematic block diagram of a communication system in accordance with an embodiment of the present disclosure;

FIG. 17 is a flowchart illustrating a method implemented in a communication system, in accordance with one embodiment of the present disclosure;

FIG. 18 is a flowchart illustrating a method implemented in a communication system, in accordance with one embodiment of the present disclosure;

FIG. 19 is a flowchart illustrating a method implemented in a communication system, in accordance with one embodiment of the present disclosure; and

FIG. 20 is a flowchart illustrating a method implemented in a communication system, in accordance with one embodiment of the present disclosure.

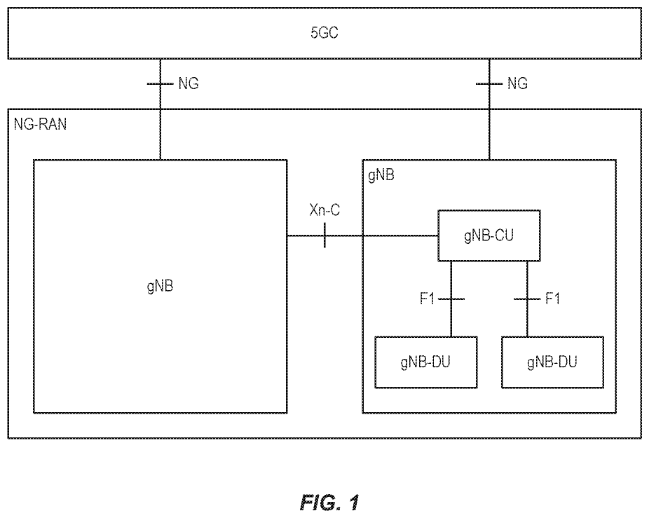

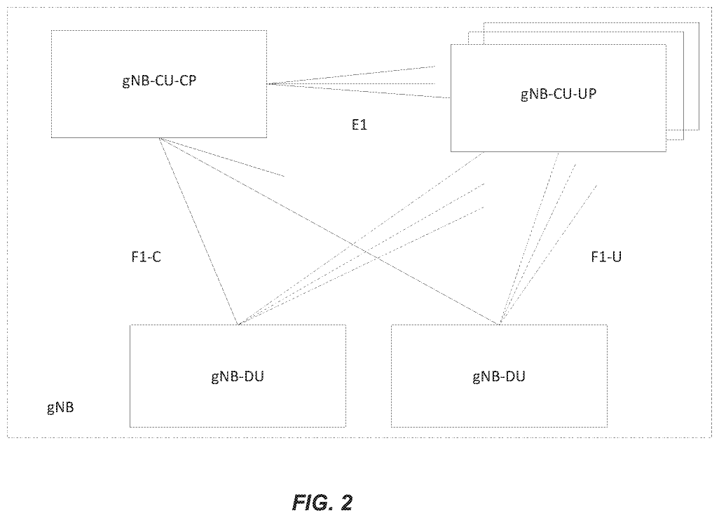

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The problem with the existing solution lies in the high processing cost associated with Flow Control (FC). As such, it may be desirable to minimize the usage of FC and aggregation. Notably, it may be difficult to accurately determine whether aggregation is needed for a Radio Bearer (RB) when the RB is established. Instead, the need to activate aggregation and FC depends on whether traffic on an RB ramps up enough to benefit from the aggregation. Moreover, the need to activate aggregation and FC can vary over time for each RB.

When FC and aggregation are active, Active Queue Management (AQM) is performed in the Packet Data Convergence Protocol (PDCP) Service Data Unit (SDU) buffer. Notably, it is not efficient to perform AQM in the Radio Link Control (RLC) SDU buffer individually during aggregation. This is because AQM activated on a poor performing leg can negatively impact overall performance when another leg is performing well.

When FC is off, only one leg can be used for transmission and all packets are buffered in the RLC SDU buffer, as opposed to being buffered in the PDCP SDU buffer. This means that AQM shall be performed in the RLC SDU buffer. Unfortunately, it may be difficult to dynamically activate or deactivate FC for an RB when AQM is active in the PDCP SDU buffer or the RLC SDU buffer for the RB.

Certain aspects of the present disclosure and their embodiments may provide solutions to the aforementioned or other challenges. Embodiments disclosed herein are related to systems and methods for dynamically activating/deactivating FC for an RB, which involves controlling which AQM buffer to activate over time. In one embodiment, a method for dynamically activating/deactivating FC for an RB, which involves controlling which AQM buffer to activate over time, includes:
providing a trigger for determining when FC should be activated or deactivated,
exchanging signaling to coordinate involved nodes (legs) on each RB, and
performing an optimal configuration based on the above signaling. The configuration between the involved nodes (legs) may include AQM usage and FC feedback activation/deactivation.

Note that embodiments of the method disclosed herein are applicable not only to LTE-NR Dual Connectivity (DC), but also to NR-NR DC, despite that the NR-NR DC aspect is not elaborated in the present disclosure.

There are, proposed herein, various embodiments which address one or more of the issues disclosed herein. In a non-limiting example, a wireless device and a base station can be configured to enable dynamically switching between an FC activated state (e.g., FC and aggregation enabled and AQM configured in PDCP SDU buffer) and an FC deactivated state (e.g., FC and aggregation disabled and AQM configured in RLC SDU buffer) based on an identical process.

In this regard, in one aspect, a method performed by a wireless device for dynamically switching between an FC activated state and an FC deactivated state is provided. The method includes determining whether there is a need to trigger an FC configuration change (e.g., from the FC activated state to the FC deactivated state, or vice versa). The method also includes triggering the FC configuration change in response to determining that the FC configuration change is needed.

In another aspect, a method performed by a base station for dynamically switching between an FC activated state and an FC deactivated state is provided. The method includes determining whether there is a need to trigger an FC configuration change (e.g., from the FC activated state to the FC deactivated state, or vice versa). The method also includes triggering the FC configuration change in response to determining that the FC configuration change is needed.

Certain embodiments may provide one or more of the following technical advantage(s). The method disclosed herein enables higher RAN capacity as a result of efficient FC activation/deactivation for active RBs, while maintaining a controlled end user latency (buffer) by activating AQM in an appropriate buffer.

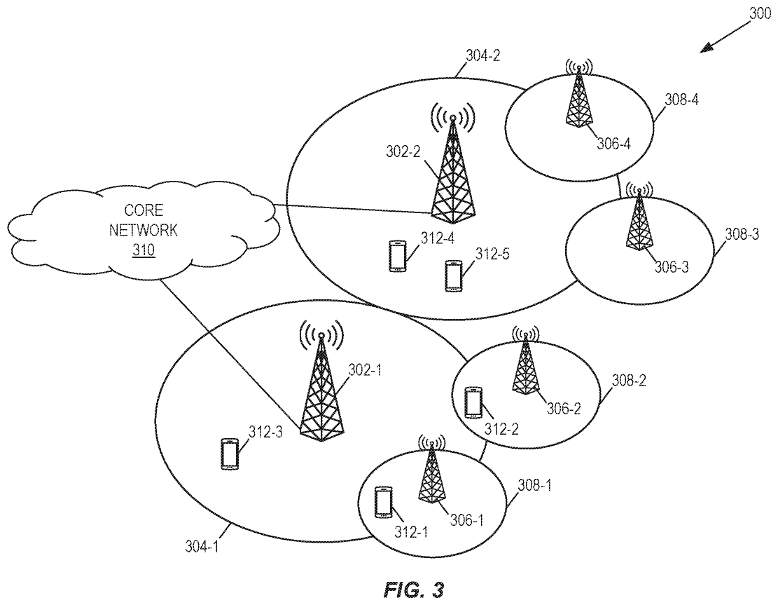

FIG. 3 illustrates one example of a cellular communications system 300 in which embodiments of the present disclosure may be implemented. In the embodiments described herein, the cellular communications system 300 is a 5G System (5GS) including a Next-Generation RAN (NG-RAN). In this example, the NG-RAN includes base stations 302-1 and 302-2, which includes 5G NR base stations (referred to as gNBs) and LTE base stations connected to the 5GC (referred to as ng-eNBs), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G Core (5GC). The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

The embodiments described herein relate to LTE-NR DC but are also applicable to NR-NR DC.

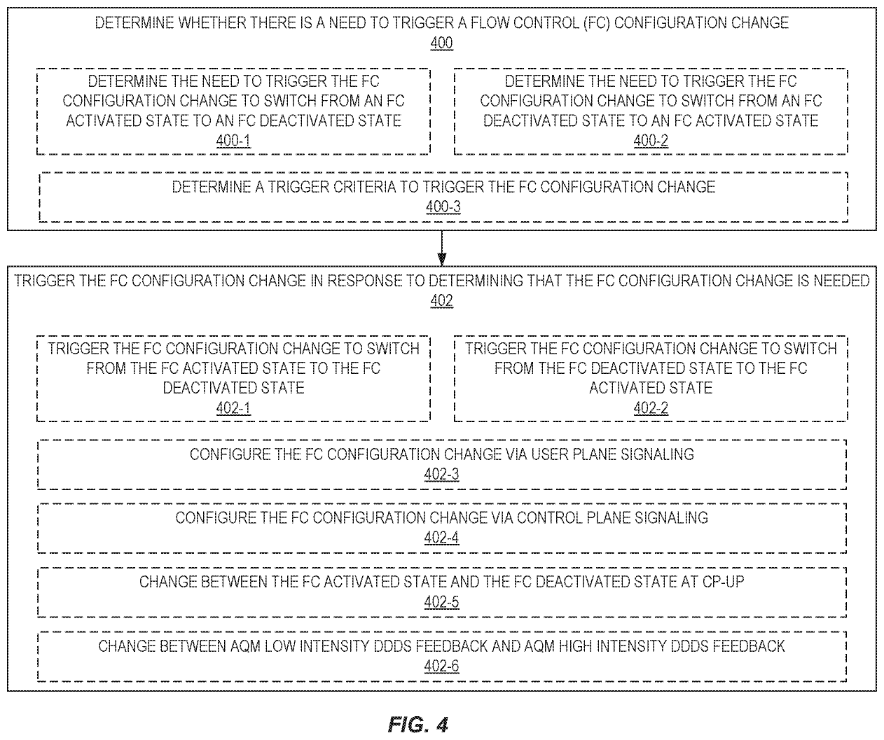

FIG. 4 is a flowchart of a method performed by a wireless device for dynamically triggering an FC configuration change. According to the method, the wireless device determines whether there is a need to trigger an FC configuration change (step 400). Specifically, the wireless device determines the need to trigger the FC configuration change to switch from an FC activated state to an FC deactivated state (400-1) or to switch from the FC deactivated stated to the FC activated state (step 400-2). The wireless device may further determine a trigger criteria to trigger the FC configuration change (step 400-3).

In response to determining that the FC configuration change is needed, the wireless device triggers the FC configuration change (step 402). Specifically, the wireless device can trigger the FC configuration change to switch from an FC activated state to an FC deactivated state (402-1) or to switch from the FC deactivated stated to the FC activated state (step 402-2). The wireless device may configure the FC configuration change via User Plane signaling (step 402-3) or Control Plane signaling (step 402-4). The wireless device may change between the FC activated state and the FC deactivated state at CP-UP (step 402-5). The wireless device may also change between AQM low intensity DDDS feedback and AQM high intensity DDDS feedback (step 402-6).

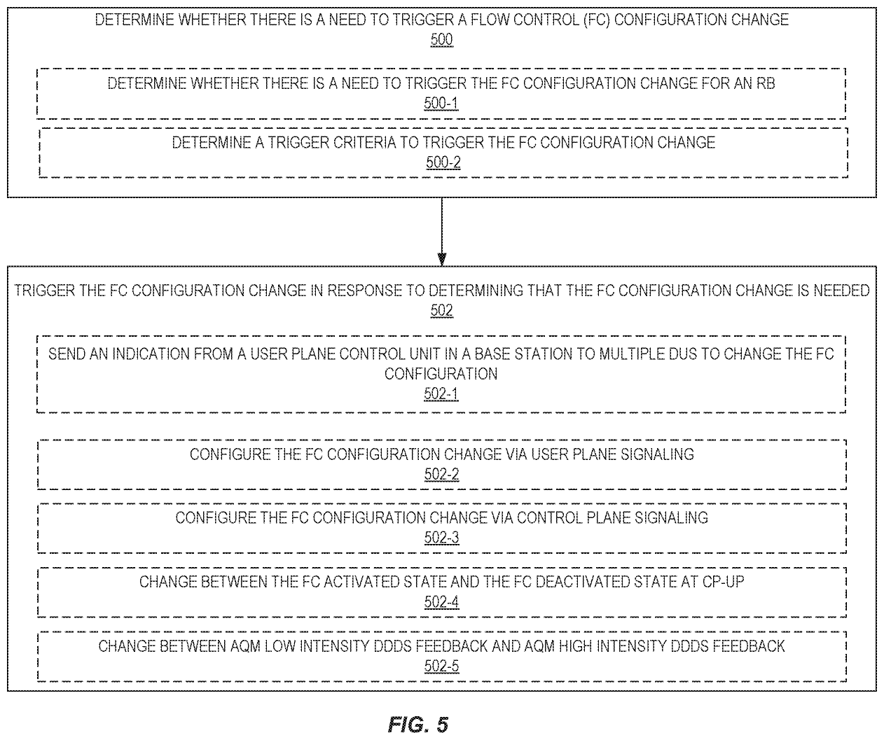

FIG. 5 is a flowchart of a method performed by a base station for dynamically triggering an FC configuration change. According to the method, the base station determines whether there is a need to trigger an FC configuration change (step 500). Specifically, the base station determines whether there is a need to trigger the FC configuration change for an RB (step 500-1). The base station may further determine a trigger criteria to trigger the FC configuration change (step 500-2).

In response to determining that the FC configuration change is needed, the base station triggers the FC configuration change (step 502). Specifically, the base station sends an indication from a User Plane Control unit in the base station to multiple DUs to change the FC configuration (step 502-1). The base station may configure the FC configuration change via User Plane signaling (step 502-2) or Control Plane signaling (step 502-3). The base station may change between the FC activated state and the FC deactivated state at CP-UP (step 502-4). The base station may also change between AQM low intensity DDDS feedback and AQM high intensity DDDS feedback (step 502-5).

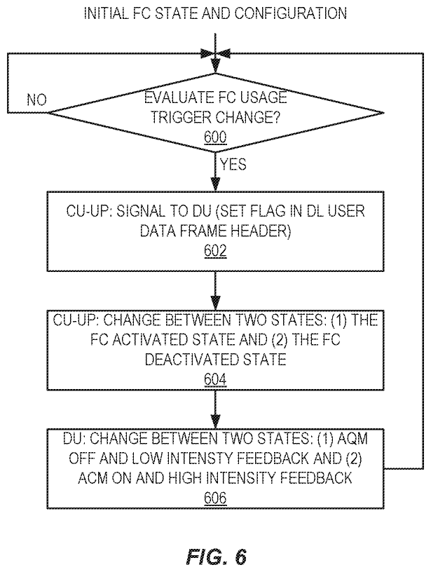

FIG. 6 is a flowchart of an exemplary process performed by a radio node (e.g., a base station and/or a wireless device) for dynamically switching between an FC activated state and an FC deactivated state in accordance with one embodiment of the present disclosure. More specifically, at establishment of a Split Radio Bearer, the radio node can be configured either to:
1. (e.g., 402) Enable FC and aggregation (e.g., using both legs for transmission) as well as configure AQM in the PDCP SDU buffer—hereinafter referred to as the “FC activated state”
2. (e.g., 402) Disable FC and aggregation (e.g., use single leg for transmission) and configure AQM in the RLC SDU buffer—hereinafter referred to as the “FC deactivated state”

In the first step in the process of FIG. 6, a triggering node evaluates present usage of FC to determine whether there is a need to trigger an FC configuration change (e.g., from the FC activated state to the FC deactivated state (step 402-1), or vice versa (step 402-2)) (step 400, 500, 600). The triggering node may be, e.g., any of the involved nodes (legs), but preferably the triggering node is the CU-UP (e.g., step 402-5) as the CU-UP has most relevant information for the evaluation. The determination in step 400, 500, 600 to switch between the FC activated state and the FC deactivated state is based on one or more trigger criteria (e.g., step 400-3, 500-2), where the one or more trigger criteria can be one or more of the following:
Load condition—reaching a preconfigured load level for CU-UP processing or F1-U interface,
Admission condition—reaching a configured number of RB or UEs using DL PDCP Aggregation or Flow control,
Estimated or measured characteristics expected to require FC or aggregation to be activated/deactivated, and/or
Other criteria that may apply.

If a decision has been made to switch states, affected node(s) (leg(s)) for the FC configuration change. This configuration is performed by signaling from the triggering node to the other node(s). There is a set of different alternatives available as:
user plane signaling (e.g., step 402-3, 502-2)
   from CU-UP to DU
   from DU to CU-UP
control plane signaling (e.g., step 402-4, 502-3)
   from CU-UP to CU-CP and then from CU-CP to DU/DUs (CU-UP as trigger)
   from CU-CP to DU/DUs and CU-UP (CU-CP as trigger)

In the illustrated example of FIG. 6, the CU-UP signals to the DU(s) to configure the affected node(s) for the FC configuration change (step 402, 502, 602). For instance, the CU-UP may set a flag in a DL user data frame header.

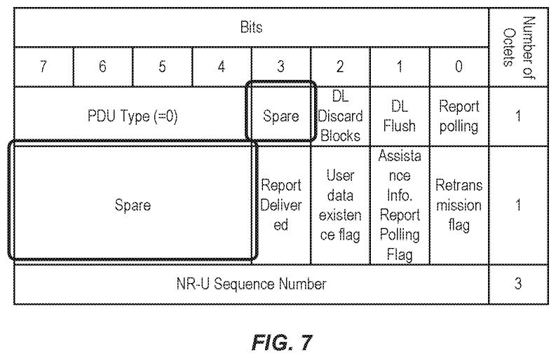

The most optimal solution is to use user plane inbound signaling from CU-UP to DU/DUs (e.g., step 502-1). As illustrated in a non-limiting example in FIG. 7, one of the current spare bits in the header of the Downlink User Data frame, as specified in TS 38.425, can be used to indicate the FC activated state and the FC deactivated state. Notably, it may also be possible to add a proprietary extension to indicate the FC configuration change. By using the current spare bits to indicate the FC configuration change, there is no additional signaling required since the indication is appended to transmissions of user data frames. The indication for the FC configuration change may be provided in every user data frame such that a single packet loss will not jeopardize the FC configuration change.

Returning to the process of FIG. 6, upon receiving the indication for the FC configuration change, one or more of the followings may occur in each node (leg):
CU-UP: change between two states: 1) the FC activated state; and 2) the FC deactivated state (step 604);
DU: change between the two states: 1) AQM off and low intensity DDDS feedback; and 2) AQM on and high intensity DDDS feedback (step 402-6, 502-5, 606)
   Where low intensity DDDS feedback is introduced to limit the DDDS signaling. This can for example be a prohibit time between each DDDS sent or turn off autonomous DDDS transmission (w/ or w/o exemption for RLC Status report triggered DDDSs). It shall be noticed that according to 3GPP TS38.425, the CU-UP can request DDDS based on a defined polling flag (Report polling) in the DL user data frame header.

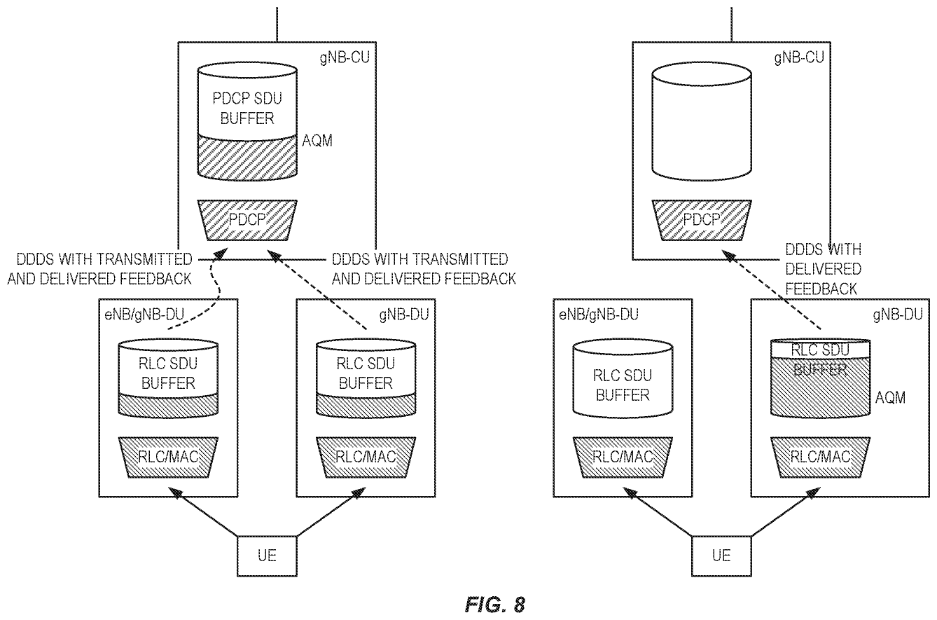

FIG. 8 provides an exemplary illustration of the FC activated state (left figure) and the FC deactivated state (right figure). The left figure shows that when FC and aggregation is on (the FC activated state), the CU-UP sends packets to the two legs and AQM is located in the PDCP SDU buffer.

The right figure shows that when FC is not active (the FC deactivated state), the CU-UP sends packets to only one leg and without controlling the rate. AQM is performed in the RLC SDU buffer.

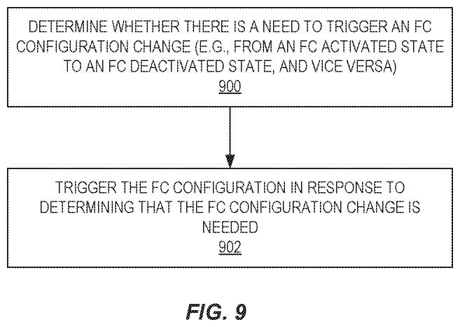

FIG. 9 is a flowchart of an exemplary method, which can be performed by a radio node (e.g., a base station and/or a wireless device), for dynamically switching between an FC activated state and an FC deactivated state. In a non-limiting example, the radio node can be a gNB and the method of FIG. 9 can be performed by the CU-UP node/entity in the gNB. The method includes determining whether there is a need to trigger an FC configuration change (e.g., from the FC activated state to the FC deactivated state, and vice versa) (step 900). The method also includes triggering the FC configuration change in response to determining that the FC configuration change is needed (step 902).

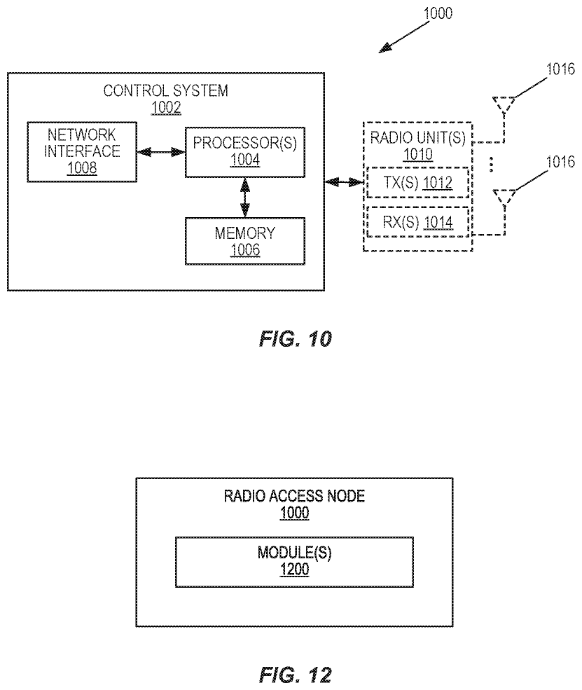

FIG. 10 is a schematic block diagram of a radio access node 1000 according to some embodiments of the present disclosure. Optional features are represented by dashed boxes. The radio access node 1000 may be, for example, a base station 302 or 306 or a network node that implements all or part of the functionality of the base station 302 or gNB described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

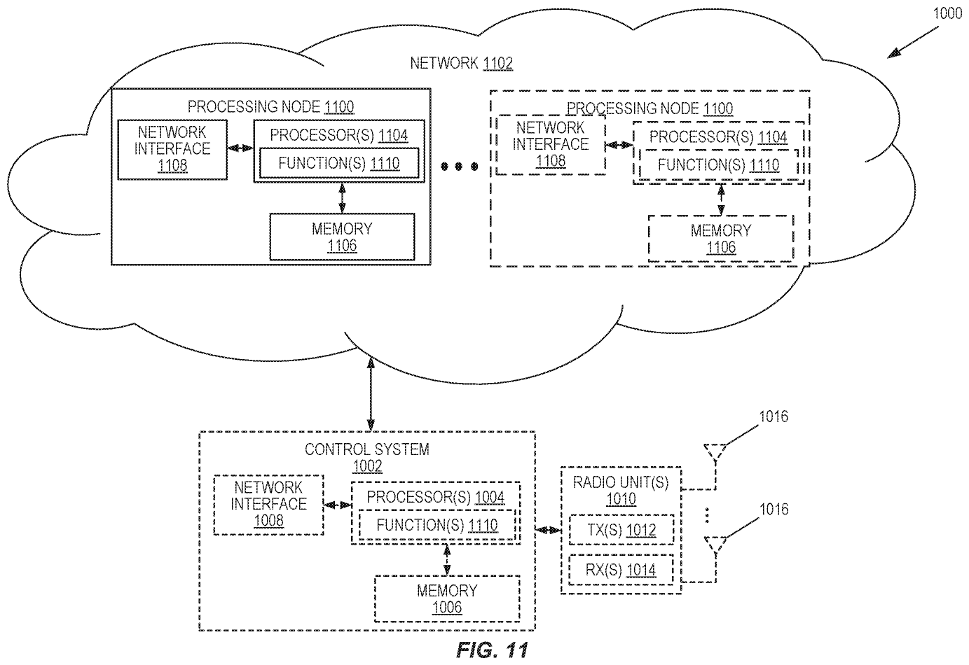

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicates directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

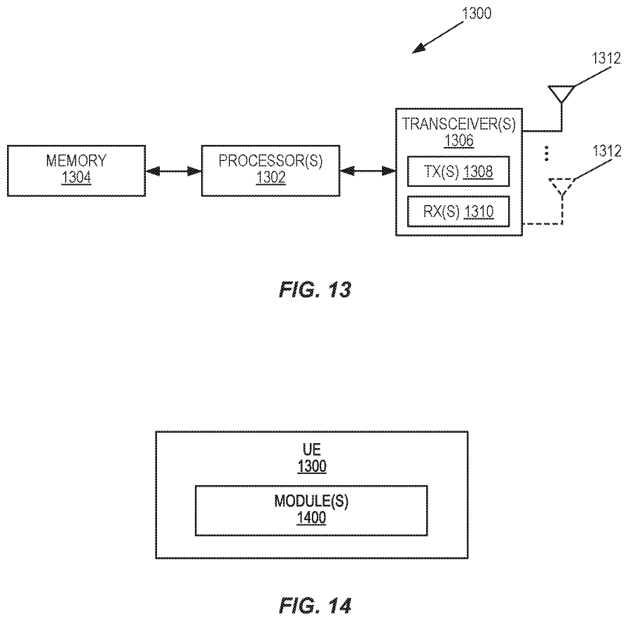

FIG. 13 is a schematic block diagram of a wireless communication device 1300 according to some embodiments of the present disclosure. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein.

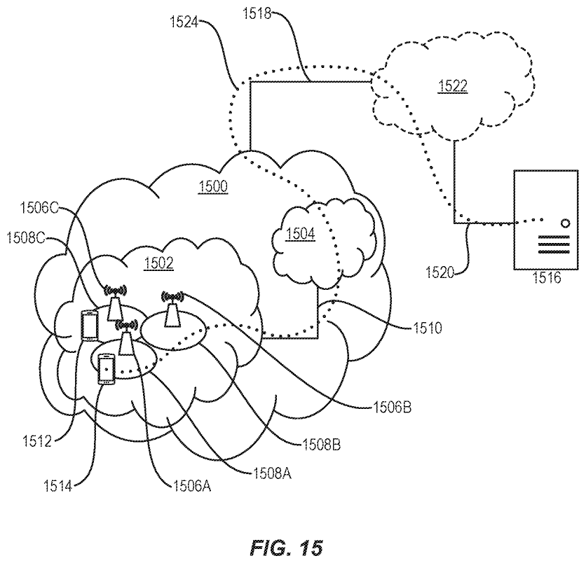

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

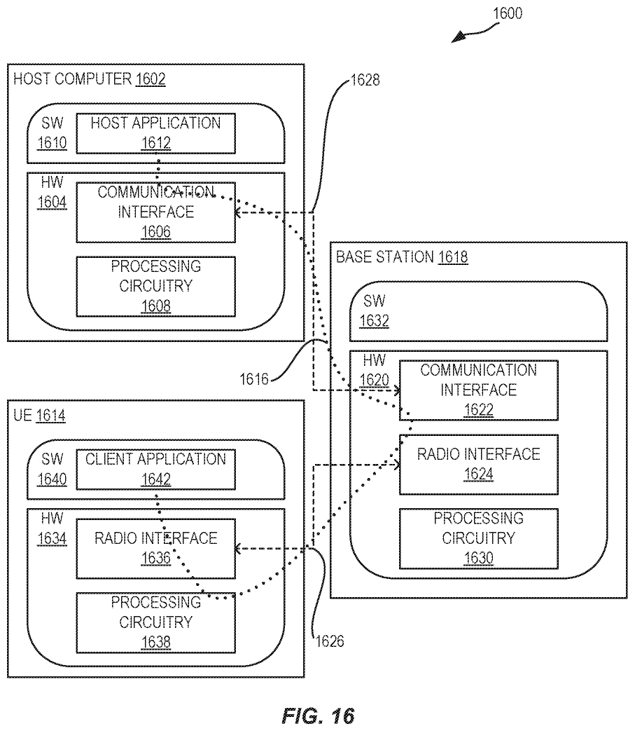

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve RAN capacity and thereby provide benefits such as reduced end user latency.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer 1602's measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

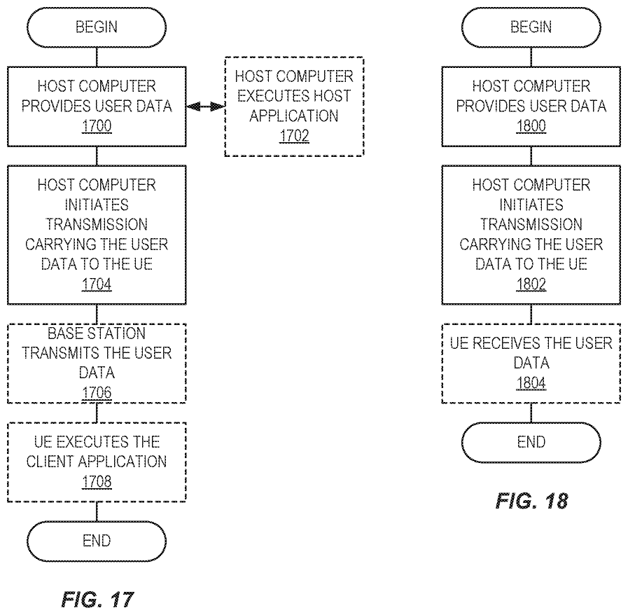

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

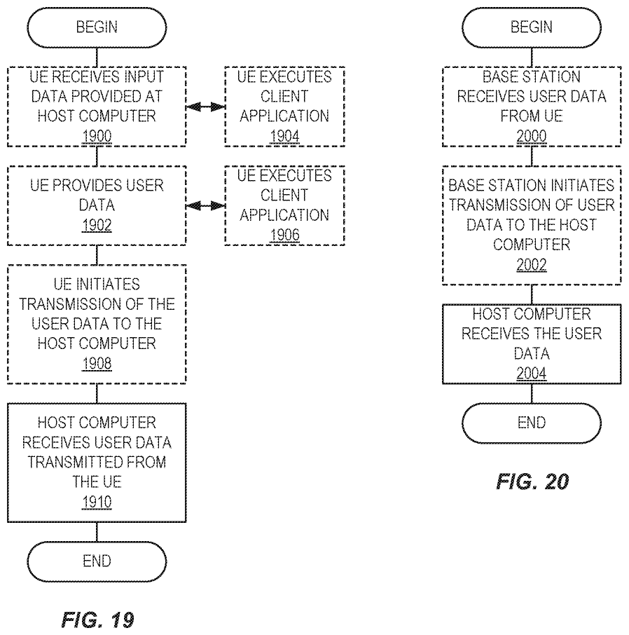

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments of the present disclosure are as follows.

Embodiment 1: A method performed by a wireless device for dynamically switching between a flow control (FC) activated state (e.g., FC and aggregation enabled and AQM configured in PDCP SDU buffer) and an FC deactivated state (e.g., FC and aggregation disabled and AQM configured in RLC SDU buffer) is provided. The method includes determining (900) whether there is a need to trigger an FC configuration change (e.g., from the FC activated state to the FC deactivated state, or vice versa). The method also includes triggering (902) the FC configuration change in response to determining that the FC configuration change is needed.

Embodiment 2: determining (900) whether there is the need to trigger the FC configuration change comprises determining a trigger criteria to switch between the FC activated stated and the FC deactivated state based on one or more of the following factors:
load condition—reaching a preconfigured load level for CU-UP processing or F1-U interface;
admission condition—reaching a configured number of radio bearers (RB) or user equipment (UEs) using DL PDCP Aggregation or Flow control; and
estimated or measured characteristics expected to require FC or aggregation to be activated/deactivated.

Embodiment 3: triggering (902) the FC configuration change comprises configuring an affected node(s) for the FC configuration change via user plane signaling (e.g., from CU-UP to DU or from DU to CU-UP) and/or control plane signaling (e.g., from CU-UP to CU-CP and then from CU-CP to DU/DUs or from CU-CP to DU/DUs and CU-UP).

Embodiment 4: in the FC activated state, FC and aggregation are on, the CU-UP sends packets to two legs and AQM is located in the PDCP SDU buffer; and in the FC deactivated state, FC and aggregation are off, the CU-UP sends packets to only one leg and without controlling rate. AQM is performed in the RLC SDU buffer.

Embodiment 5: the user plane signaling and/or the control plane signaling are provided in one or more of following methods:
using a spare bit(s) in a header of downlink user data frame (e.g., as specified in TS 38.425) or reusing a bit already defined in 3GPP standard;
using a multi-bit field;
using a new user plane message (e.g., does not exist at present); and
using a control plane message.

Embodiment 6: the user plane signaling and/or the control plane signaling are provided via an existing header or a proprietary extension to the header of downlink user data frame.

Embodiment 7: The method further includes performing one or more of the following actions in response to receiving the user plane signaling and/or the control plane signaling:
change between the FC activated state and the FC deactivated state at CU-UP; and
change between AQM off/low intensity DDDS feedback and AQM on/high intensity DDDS feedback.

Embodiment 8: The method further includes providing user data and forwarding the user data to a host computer via the transmission to the base station.

Embodiment 9: A method performed by a base station for dynamically switching between a flow control (FC) activated state (e.g., FC and aggregation enabled and AQM configured in PDCP SDU buffer) and an FC deactivated state (e.g., FC and aggregation disabled and AQM configured in RLC SDU buffer) is provided. The method includes determining (900) whether there is a need to trigger an FC configuration change (e.g., from the FC activated state to the FC deactivated state, or vice versa). The method also includes triggering (902) the FC configuration change in response to determining that the FC configuration change is needed.

Embodiment 10: the base station comprises a user plane control unit (e.g., CU-UP) and two distributed units (e.g., DUs), and: determining (900) whether there is a need to trigger an FC configuration change comprises determining whether there is a need to trigger an FC configuration change for a radio bearer (RB) comprising a first leg that corresponds to a first DU and a second leg that corresponds to a second DU.

Embodiment 11: trigging (902) the FC configuration change comprises sending an indication from the user plane control unit to the first and second DUs, the indication being an indication to switch the FC configuration.

Embodiment 12: determining (900) whether there is the need to trigger the FC configuration change comprises determining a trigger criteria to switch between the FC activated stated and the FC deactivated state based on one or more of the following factors:
load condition—reaching a preconfigured load level for CU-UP processing or F1-U interface;
admission condition—reaching a configured number of RB or UEs using DL PDCP Aggregation or FC; and
estimated or measured characteristics expected to require FC or aggregation to be activated/deactivated.

Embodiment 13: triggering (902) the FC configuration change comprises configuring an affected node(s) for the FC configuration change via user plane signaling (e.g., from CU-UP to DU or from DU to CU-UP) and/or control plane signaling (e.g., from CU-UP to CU-CP and then from CU-CP to DU/DUs or from CU-CP to DU/DUs and CU-UP).

Embodiment 14: in the FC activated state, FC and aggregation are on, the CU-UP sends packets to two legs and AQM is located in the PDCP SDU buffer; and in the FC deactivated state, FC and aggregation are off, the CU-UP sends packets to only one leg and without controlling rate. AQM is performed in the RLC SDU buffer.

Embodiment 15: the user plane signaling and/or the control plane signaling are provided in one or more of following methods:
using a spare bit(s) in a header of downlink user data frame (e.g., as specified in TS 38.425) or reusing a bit already defined in 3GPP standard;
using a multi-bit field;
using a new user plane message (e.g., does not exist at present); and
using a control plane message.

Embodiment 16: the user plane signaling and/or the control plane signaling are provided via an existing header or a proprietary extension to the header of downlink user data frame.

Embodiment 17: The method further includes performing one or more of the following actions in response to receiving the user plane signaling and/or the control plane signaling:
change between the FC activated state and the FC deactivated state at CU-UP; and
change between AQM off/low intensity DDDS feedback and AQM on/high intensity DDDS feedback.

Embodiment 18: The method further includes obtaining user data and forwarding the user data to a host computer or a wireless device.

Embodiment 19: A wireless device for dynamically switching between a flow control (FC) activated state (e.g., FC and aggregation enabled and AQM configured in PDCP SDU buffer) and an FC deactivated state (e.g., FC and aggregation disabled and AQM configured in RLC SDU buffer). The wireless device comprising:
processing circuitry configured to perform any of the steps of any of the embodiments performed by the wireless device; and
power supply circuitry configured to supply power to the wireless device.

Embodiment 20: A base station for dynamically switching between a flow control (FC) activated state (e.g., FC and aggregation enabled and AQM configured in PDCP SDU buffer) and an FC deactivated state (e.g., FC and aggregation disabled and AQM configured in RLC SDU buffer). The base station comprising:
processing circuitry configured to perform any of the steps of any of the embodiments performed by the base station; and
power supply circuitry configured to supply power to the base station.

Embodiment 21: A User Equipment, UE, for dynamically switching between a flow control (FC) activated state (e.g., FC and aggregation enabled and AQM configured in PDCP SDU buffer) and an FC deactivated state (e.g., FC and aggregation disabled and AQM configured in RLC SDU buffer). The UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 22: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the embodiments performed by the base station.

Embodiment 23: The communication system further includes the base station.

Embodiment 24: The communication system further includes the UE, wherein the UE is configured to communicate with the base station.

Embodiment 25: The communication system, wherein:
the processing circuitry of the host computer is configured to execute a host application, thereby providing the user data; and
the UE comprises processing circuitry configured to execute a client application associated with the host application.

Embodiment 26: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the base station performs any of the steps of any of the embodiments performed by the base station.

Embodiment 27: The method further comprising, at the base station, transmitting the user data.

Embodiment 28: wherein the user data is provided at the host computer by executing a host application, the method further comprising, at the UE, executing a client application associated with the host application.

Embodiment 29: A User Equipment, UE, configured to communicate with a base station, the UE comprising a radio interface and processing circuitry configured to perform the method of the previous three embodiments.

Embodiment 30: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the embodiments performed by the wireless device.

Embodiment 31: the cellular network further includes a base station configured to communicate with the UE.

Embodiment 32: The communication system, wherein:
the processing circuitry of the host computer is configured to execute a host application, thereby providing the user data; and
the UE's processing circuitry is configured to execute a client application associated with the host application.

Embodiment 33: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the embodiments performed by the wireless device.

Embodiment 34: The method further comprising at the UE, receiving the user data from the base station.

Embodiment 35: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the embodiments performed by the wireless device.

Embodiment 36: The communication system, further including the base station, wherein the base station comprises a radio interface configured to communicate with the UE and a communication interface configured to forward to the host computer the user data carried by a transmission from the UE to the base station.

Embodiment 37: The communication system, further including the UE.

Embodiment 38: The communication system, wherein:
the processing circuitry of the host computer is configured to execute a host application; and
the UE's processing circuitry is configured to execute a client application associated with the host application, thereby providing the user data.

Embodiment 39: The communication system, wherein:
the processing circuitry of the host computer is configured to execute a host application, thereby providing request data; and
the UE's processing circuitry is configured to execute a client application associated with the host application, thereby providing the user data in response to the request data.

Embodiment 40: A method implemented in a communication system including a host computer, a base station, and a User Equipment, UE, the method comprising at the host computer, receiving user data transmitted to the base station from the UE, wherein the UE performs any of the steps of any of the embodiments performed by the wireless device.

Embodiment 41: The method further comprising, at the UE, providing the user data to the base station.

Embodiment 42: The method further comprising:
at the UE, executing a client application, thereby providing the user data to be transmitted; and
at the host computer, executing a host application associated with the client application.

Embodiment 43: The method further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 44: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the embodiments performed by the base station.

Embodiment 45: The communication system, further including the UE, wherein the UE is configured to communicate with the base station.

Embodiment 46: The communication system further including the base station.

Embodiment 47: The communication system, wherein:
the processing circuitry of the host computer is configured to execute a host application; and
the UE is configured to execute a client application associated with the host application, thereby providing the user data to be received by the host computer.

Embodiment 48: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the embodiments performed by the wireless device.

Embodiment 49: The method further comprising at the base station, receiving the user data from the UE.

Embodiment 50: The method further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
AQM Active Queue Management
ASIC Application Specific Integrated Circuit
AUSF Authentication Server Function
CPU Central Processing Unit
CU-CP Central Unit-Control Plane
CU-UP Central Unit-User Plane
DC Dual Connectivity
DDDS Downlink Data Delivery Status
DN Data Network
DSP Digital Signal Processor
DU Distributed Unit
eNB Enhanced or Evolved Node B
FC Flow Control
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PDCP Packet Data Convergence Protocol
P-GW Packet Data Network Gateway
QoS Quality of Service
RB Radio Bearer
RAM Random Access Memory
RAN Radio Access Network
RLC Radio Link Control
ROM Read Only Memory
RRH Remote Radio Head
RU Round Trip Time
SCEF Service Capability Exposure Function
SDU Service Data Unit
SMF Session Management Function
TCP Transport Control Protocol
TN Transport Network
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless device for dynamically triggering a Flow Control, FC, configuration change, comprising:
determining whether there is a need to trigger the FC configuration change; and
triggering the FC configuration change in response to determining that the FC configuration change is needed.

2. The method of claim 1, wherein:
determining the need to trigger the FC configuration change comprises one of:
determining the need to trigger the FC configuration change to switch from an FC activated stated to an FC deactivated state; and
determining the need to trigger the FC configuration change to switch from the FC deactivated state to the FC activated state; and
triggering the FC configuration change comprises one of:
triggering the FC configuration change to switch from the FC activated stated to the FC deactivated state; and
triggering the FC configuration change to switch from the FC deactivated state to the FC activated state.

3. The method of claim 2, wherein:
the FC activated state comprises:
enablement of FC and aggregation; and
configuration of Active Queue Management, AQM, for a Packet Data Convergence Protocol, PDCP, Service Data Unit, SDU, buffer; and
the FC deactivated state comprises:
disablement of FC and aggregation; and
configuration of AQM for a Radio Link Control, RLC, SDU buffer.

4. The method of claim 2, wherein determining the need to trigger the FC configuration change further comprises determining a trigger criteria to trigger the FC configuration change based on one or more of:
a load condition;
an admission condition; and
an estimated or measured characteristic expected to require activation or deactivation of FC and aggregation.

5. The method of claim 2, wherein triggering the FC configuration change further comprises one or more of:
configuring the FC configuration change via user plane signaling; and
configuring the FC configuration change via control plane signaling.

6. The method of claim 5, wherein the user plane signaling and/or the control plane signaling are provided in one or more of following methods:
a spare bit(s) in a header of downlink user data frame;
a multi-bit field;
a new user plane message; and
a control plane message.

7. The method of claim 6, wherein the user plane signaling and/or the control plane signaling is provided via an existing header or a proprietary extension to the header of downlink user data frame.

8. The method of claim 6, wherein triggering the FC configuration change further comprises one or more of:
changing between the FC activated state and the FC deactivated state at Central Unit Control Plane, CP-UP; and
changing between AQM low intensity Downlink Data Delivery Status, DDDS, feedback and AQM high intensity DDDS feedback.

9. A wireless device, comprising:
processing circuitry and transceiver circuitry configured to cause the wireless device to:
determine whether there is a need to trigger the FC configuration change; and
trigger the FC configuration change in response to determining that the FC configuration change is needed; and
power supply circuitry configured to supply power to the wireless device.

10. (canceled)

11. A method performed by a base station for dynamically triggering a Flow Control, FC, configuration change, comprising:
determining whether there is a need to trigger the FC configuration change; and
triggering the FC configuration change in response to determining that the FC configuration change is needed.

12. The method of claim 11, wherein:
determining the need to trigger the FC configuration change comprises determining whether there is a need to trigger the FC configuration change for a Radio Bearer, RB, comprising multiple legs each corresponding to a respective one of multiple Distributed Units, DUs, in the base station; and
triggering the FC configuration change comprises sending an indication from a User Plane Control Unit in the base station to the multiple DUs to change the FC configuration.

13. The method of claim 11, wherein:
the FC activated state comprises:
enablement of FC and aggregation; and
configuration of Active Queue Management, AQM, for a Packet Data Convergence Protocol, PDCP, Service Data Unit, SDU, buffer; and
the FC deactivated state comprises:
disablement of FC and aggregation; and
configuration of AQM for a Radio Link Control, RLC, SDU buffer.

14. The method of claim 13, wherein determining the need to trigger the FC configuration change further comprises determining a trigger criteria to trigger the FC configuration change based on one or more of:
a load condition;
an admission condition; and
an estimated or measured characteristic expected to require activation or deactivation of FC and aggregation.

15. The method of claim 12, wherein triggering the FC configuration change further comprises one or more of:
configuring the FC configuration change via user plane signaling; and
configuring the FC configuration change via control plane signaling.

16. The method of claim 15, wherein the user plane signaling and/or the control plane signaling are provided in one or more of following methods:
a spare bit(s) in a header of downlink user data frame;
a multi-bit field;
a new user plane message; and
a control plane message.

17. The method of claim 16, wherein the user plane signaling and/or the control plane signaling is provided via an existing header or a proprietary extension to the header of downlink user data frame.

18. The method of claim 16, wherein triggering the FC configuration change further comprises one or more of:
changing between the FC activated state and the FC deactivated state at Central Unit Control Plane, CP-UP; and
changing between AQM low intensity Downlink Data Delivery Status, DDDS, feedback and AQM high intensity DDDS feedback.

19. A base station, comprising:
a control system configured to cause the base station to:
determine whether there is a need to trigger the FC configuration change; and
trigger the FC configuration change in response to determining that the FC configuration change is needed.

20. (canceled)
